(19) United States
(12) Patent Application Publication
(10) Pub. No.: US 2005/0038185 A1
(43) Pub. Date: Feb. 17, 2005

(54) Multi-polymer blends

(75) Inventor: Donald J. Sullivan, Albuquerque, NM (US)

Correspondence Address: FISH & RICHARDSON PC, 225 FRANKLIN ST, BOSTON, MA, 02110, US

(73) Assignee: Green Polymer Technologies, Inc., Albuquerque, NM (US)

(21) Appl. No.: 10/950,008

(22) Filed: Sep. 24, 2004

Related U.S. Application Data
(63) Continuation of application No. 10/215,413, filed on Aug. 7, 2002, now abandoned.
(60) Provisional application No. 60/310,545, filed on Aug. 7, 2001.

(51) Int. Cl. C08L 51/08

(52) U.S. Cl. 525/63

(57) ABSTRACT

A method for blending multiple immiscible polymers resulting in a fine morphology with good interfacial adhesion is disclosed. The method can include melt compounding more than two immiscible polymers with different viscosity ratios in the presence of more than one compatibilizer. The immiscible polymers may be chosen from a wide range of materials including but not limited to thermoplastics, elastomers, thermoplastic elastomers, fibers or composites of any of the aforementioned polymers. The compatibilizers may take the form of block copolymers, graft copolymers, random copolymers or other polymers known to reduce the interfacial tension of the immiscible polymers present in the blend. The compatibilizers may be functionalized to further reduce the size of the final morphology of the new polymer alloy. This method has been found to be advantageous in recycling commingled plastic wastes.

### BACKGROUND

The invention relates to polymer blends containing at least three immiscible polymers.

New polymer blends, which are mixtures of existing polymers, are constantly being developed as a means of deriving materials with new and desirable properties. Engineers and scientists are continually searching for that combination of polymers which will yield the necessary mix of improved physical, thermal, optical, electrical or other properties. Developing blends has proven to be far more successful than inventing new homopolymers from scratch with the appropriate material characteristics. Indeed, as of 1994, the business of manufacturing polymer blends accounted for more than 30% of the annual worldwide production of over 110 million metric tons of product.

Unfortunately, the development of new polymer blends is usually a difficult task. This results from the fact that most polymers do not mix, i.e., thermodynamically immiscible. Chapter 3 of Sperling gives a detailed discussion of the thermodynamics of mixing, the solubility parameter, and intrinsic viscosity, which are incorporated herein by reference. Sperling L. H., Introduction to Physical Polymer Science, Second Edition, J. Wiley and Sons, New York, 1992.The arbitrary mixture of two polymers usually results in an alloy that is physically weak and consists of large drops of the minor constituent suspended in a matrix formed by the major component. Much research over many decades has resulted in success with a limited number of blends. However, these blends usually consist of only two components. Furthermore, most are composed of the major and minor constituent such that the major polymer component is 75% or more by weight of the combination. The blend is normally mixed in the presence of a compatibilizer, which is used to lower the interfacial tension between the components. Lowering the interfacial tension results in smaller drops suspended in the matrix. The larger surface area, where the two components adhere to each other, leads to a stronger material with a more uniform distribution of the other properties for which the original polymers were chosen. A discussion of these issues including phase separation and fractionation, polymer-polymer phase separation, and multicomponent and multiphased materials is contained in Chapter 4 of Sperling cited above and is also incorporated by reference.

### SUMMARY

This invention opens up an entire new range of blends. It is not limited to two components plus a single compatibilizer. Neither is it limited to a blend where a single polymer represents the majority by weight of the polymer alloy. The invention features polymer blends containing at least three immiscible polymers. Because many different polymers are used, polymer alloys that have a broad range of properties can be designed. The blends can contain at least two different compatibilizers. The compatibilizers help to reduce the size of the final morphology of the polymer blend, which in turn helps give the blend strength and a more uniform distribution of desirable properties. The compatibilizers can also add features such as impact resistance.

The invention features a method for blending multiple immiscible polymers. The polymer alloy produced has a fine morphology with good interfacial adhesion. This results in excellent physical properties such as compressive strength, tensile strength, flexural strength, and elongation. The method includes melt compounding more than two immiscible polymers with different viscosity ratios in the presence of more than one compatibilizer.

The invention further features a means of blending a combination of immiscible polymers that may be chosen from a wide range of materials including but not limited to thermoplastics, elastomers, thermoplastic elastomers, fibers (including, e.g., wood), as well as compounds, or composites of any of the aforementioned polymers. The polymers may be amorphous or crystalline. They may be linear, branched, or nonlinear. Their form may be homopolymer, alternating copolymer, random copolymer, block copolymer, graft copolymer, terpolymers, or other complex forms. The final combination of polymers and their weight percentage in the blend can be chosen to attain the desired physical, thermal, electrical, optical, or other properties desired in the final product. Preferably the polymers are engineering polymers, and there is less than 90% (more preferably less than 70% and most preferably less than 50%) polyolefin present.

The compatibilizers may take the form of block copolymers, graft copolymers, random copolymers or other polymers known to reduce the interfacial tension of the immiscible polymers present in the blend.

One or more of the compatibilizers may take the form of polymers that are miscible with one or more of the polymers in the blend and which also reduce the interfacial tension of at least one of the immiscible polymers. One or more of the compatibilizers may be functionalized to further reduce the size of the final morphology of the new polymer alloy. This results from an in situ reaction between the functionalized group of the compatibilizer and one or more of the immiscible polymers. This is normally referred to as reactive compatibilization.

The new polymer alloy produced, which constitutes a blend of a subset of the polymers listed above, can also contain a mixture of monomers, dimers, trimers, oligomers, or additives to obtain one or more desired properties.

The polymer blend may contain inorganic fillers in order to produce a polymer compound. These fillers include but are not limited to: calcium carbonate, silica, mica, clay, flyash, aluminum trihydrate and metal oxides, which enhance such properties as impact strength, tensile strength, compressive strength and flame retardancy. Other useful additives include but are not limited to: lubricants, surfactants, colorants, pigments, and foaming agents.

The invention further features a method whereby single or multiple polymer components may be added to the mixing apparatus in solid or melt form with the appropriate compatibilizers blended with the various polymer components prior to, simultaneously with, or shortly after the polymer components are metered into the mixing apparatus.

The invention further features a method whereby some or all of the polymer components and some or all of the compatibilizers are obtained as recycled materials. The recycled materials may be recovered from post-industrial waste, off-grade material from production facilities, trim waste from fabrication processes, post-consumer waste, and numerous other sources. The solid recycled material is preferably obtained as a dry blend of pellet, granulate and/or flake pre-mixed with a specified size distribution and polymer content for a particular blend from a toll vendor.

The mixing apparatus can include a screw extruder with a minimum length to diameter ratio (L/D) of 12:1, as well as static mixers. Because of the high viscosity of the compound as it is processed, and the requirement for both dispersive and distributive mixing, the preferred embodiment is a twin-screw extruder with an L/D ratio of greater than 24:1.

The details of one or more embodiments of the invention are set forth in the accompanying figures and the description below. Other features, objects, and advantages of the invention will be apparent from the description and figures, and from the claims.

### DESCRIPTION OF FIGURES

FIGS. 1 and 2 are copies of SEM photographs of polymer blends.

### DETAILED DESCRIPTION

In order to create the preferred polymer blends, each polymer component must experience a physical as well as chemical compatibilization process. First each polymer must be melted in a mixing apparatus. This is usually accomplished through viscous heating of the material among the moving and static elements of the mixing apparatus. Once this is accomplished the polymer components undergo dispersive mixing to reduce their size and distributive mixing to result in a uniform distribution of the dispersed elements (usually drops) of each of the polymer components in the blend. This process is well known to those skilled in the art and is referenced in the book by Rauwendaal that contains detailed information on both the basic principles of mixing and mixing machinery. Rauwendaal C., Polymer Mixing: A Self-Study Guide, Hanser Publishers, Munich, 1998.

The physical compatibilization process can be broken down into several stages. These include stretching, breakup and coalescence. Stretching of a component from a drop into a thread or filament occurs when the stress exerted on the drop by the external flow field of the other components in the blend exceeds the interfacial stress built up between the thread and its surrounding matrix. In the case of miscible polymers the interfacial stress is zero so that the threads blend perfectly into the matrix leaving no dispersed component. Breakup occurs when the two stresses become comparable. Coalescence becomes important when the small drops move into a region of the mixer where flow field stress is low and drops of the same component come in contact to form larger drops. Details of the physical compatibilization process are discussed by for example Janssen Jos M. H., and Han E. H. Meijer, “Dynamics of Liquid-Liquid Mixing: a 2-Zone Model”, Polymer Engineering and Science, November 1995, Vol. 35, No. 22, pp. 1766-1780.and Franzheim O., T. Rische, M. Stephan, and W. J. Macknight, “Blending of Immiscible Polymers in a Mixing Zone of a Twin Screw Extruder—Effects of Compatibilization”, Polymer Engineering and Science, May 2000, Vol. 40, No. 5, pp. 1143-1156.

The role of chemical compatibilization is to lower the interfacial stresses between components so that breakup is delayed until smaller drops are formed, and the drop size at which coalescence takes place is reduced. This results in a finer morphology for the polymer blend with consequent enhancements to its physical properties.

The combined action of stretching and folding, which is found in most well designed static mixers but only in certain screw extruders, is important for obtaining an exponential decrease in the scale length of the dispersed phase (i.e., drop size). A finer dispersion is obtained upon increasing either the viscosity of the dispersed or continuous phase. Under these conditions, increasing the viscosity ratio of the polymer components leads to a finer morphology. Both the key role of distributive folding and a larger than unity viscosity ratio contradict conventional wisdom on the best approach to blend polymers.

The polymers are chosen so that the viscosity ratio between components is not unity. Preferably the viscosity ratio between the highest and lowest viscosity component is greater than 10, more preferably the viscosity ratio is greater than 30, 40, 50, 60, 70, or 80, and most preferably the viscosity ratio is greater than 100.

The use of multiple polymer components also enhances blend morphology and physical characteristics by creating a range of interfacial tensions among components. The lower the interfacial tension (sigma) between two components the less immiscible they are. Therefore, the sigma between component A and component B may be large; the sigma between component A and component C may be small; and the sigma between component B and component C may be an intermediate value. In this case, component A will adhere well to component C, and component B will adhere satisfactorily to component C; whereas, if component C were not present, component A would tend to form large drops in the presence of component B, in order to minimize its surface area and accordingly its interfacial stress.

This is the same principle that is used when choosing copolymers as compatibilizers. Namely, one portion of the copolymer would be at least partially miscible with component A, while the other portion would be partially miscible with component B. Therefore, if chosen properly, the number of polymer components in the blend of the subject invention can be arbitrarily large. Preferably the number of polymer components is three, more preferably it is four, and most preferably it is five or greater.

With respect to the choice of compatibilizers, the use of block copolymers is well known to those skilled in the art. In particular, the blocks in the copolymer are chosen to be miscible or partially miscible in one or more of the polymer components of the desired blend. In its most rudimentary form, the copolymers can be chosen such that the copolymer blocks are made up of the same polymers as are present in the immiscible blend. For example, if the desired polymer blend has polymers A, B, and C as components, then the compatibilizers could consist of an A-B block copolymer and a B-C block copolymer. The presence of the copolymer consisting of segments of polymer A and segments of polymer B will lower the interfacial tension on the surfaces where component polymer A and component polymer B come into contact. The same holds true for the interfacial surfaces of components B and C in the presence of copolymer B-C. The B block, which is miscible in the B component, migrates to the B surface, and the C block preferentially moves to the C surface. Thus, the copolymer binds the two surfaces together resulting in lower interfacial tension, smaller drop sizes, and a finer morphology.

However, the choice of compatibilizers is not limited to block copolymers. Because the invention features a polymer blend with a range of polymer components, it also can utilize an array of compatibilizers. As described above, these can be copolymers. They usually take the form of di-block, tri-block or higher block copolymers. Graft copolymers can also be used in certain cases. Other compatibilizers are polymers that are miscible with one component and partially miscible with one or more of the remaining components of the polymer blend. A third class of compatibilizer is a core-shell copolymer that behaves as a multipurpose compatibilizer and impact modifier. Finally, there is reactive compatibilization that is employed to generate in situ the desired quantities of block and/or graft copolymers in order to enhance domain interactions. More than one compatibilizer is used to improve the desired properties of the polymer blend. Preferably two or more copolymers are used, more preferably a combination of copolymers and a miscible polymer are used, and most preferably a combination of copolymers, a miscible polymer and a core-shell copolymer are used. In cases where the prerequisite residence time is available in the mixing apparatus, a reactive compatibilizer in the form of either a copolymer with a functionalized group (e.g., polypropylene grafted maleic anhydride), or a combination of a peroxide initiator (e.g., 2,5-bis (tert-butylperoxy)-2,5-dimethylhexyne) and a polymerizable monomer (e.g., n-butyl methacrylate), may be used. The advantages of this particular example of reactive compatibilization are discussed in Hettema R., J. Van Tol, and L. P. B. M. Janssen, “In-Situ Reactive Blending of Polyethylene and Polypropylene in Co-Rotating and Counter-Rotating Extruders”, Polymer Engineering and Science, September 1999, Vol. 39, No. 9, pp. 1628-1641.

As stated earlier, during the stretching of dispersed domains it is important for the mixing action to include stretching and folding of the polymer blend, in order to gain an exponential decrease in the diameter of the threads and subsequent drops upon disintegration of the threads. The exponential decrease is obtained through the use of static mixers, which are well designed to obtain a stretching and folding action. These include but are not limited to Ross ISG, Multiflux, Kenics, Sulzer SMX and other static mixers. Preferably a dynamic mixer such as a screw extruder is used, in order to maximize the amount of polymer blend produced per unit time. More preferably a single screw extruder such as a Buss Co-kneader is used. Even more preferably a twin-screw extruder such as a closely intermeshing co-rotating twin-screw extruder is used. Most preferably the subject invention would use a partially intermeshing or non-intermeshing counter rotating twin-screw extruder. All of the various mixing apparatus listed are well known to a person skilled in the art. In particular, the latter counter rotating twin-screw extruders are known in the art to maximize the type of distributive mixing, including multiple reorientations and material transfer between screws, that will maximize the stretching and folding action experienced by the blend.

In one embodiment, a counter rotating non-intermeshing (CRNI) twin-screw extruder is used. This mixing apparatus provides for maximum distributive mixing while controlling the amount of dispersive mixing to the minimum required for the viscous heating necessary for melting all of the polymer components and the compatibilizers. A large amount of dispersive mixing leads to excessive shear and excessively high temperature with the consequent material degradation which normally accompanies these conditions. Therefore, the elements utilized in the screw design are crucial to the proper execution of the process in this particular embodiment.

Each screw element is designed to handle a particular sub-process as the material is conveyed along the extruder. These screw elements include but are not limited to: one, two, three or higher flighted screws for positive pressure conveyance and mixing; radial vane mixers, narrow kneaders, slotted axial flow elements and similar elements for distributive mixing; and cylinders, reverse flighted screw elements, disks such as blister rings, and similar elements for zoning of the extruder in order to separate sub-processes. Zoning elements can also be designed for mixing or forwarding the extruder material. Each of these elements and their variants are well known to persons skilled in the art. Each screw element should be correlated with the length of the machine necessary to provide optimal recombination and reorientation of material in the distributive mixing and conveying sections. Also, the zoning elements should be configured to allow for a vacuum region for devolatilization of volatile constituents, such as water, from the polymer melt prior to extrusion through a die. Distributive mixing leading to rapid surface regeneration within the vacuum section leads to lower residual volatile content.

An example of the process stages is provided here. The polymer components may be obtained: from virgin resin manufacturers typically in the form of pellets or powder; from recyclate vendors as individual components, or as a mix of components, based upon a specification for a certain resin mix and particle size distribution; from post-industrial or post-consumer sources with the desired resin content and subsequently granulated to a specified size; or a combination of the above. The appropriate compatibilizers will be obtained in a similar manner.

The polymer components and compatibilizers, which will be used in the production of a particular polymer alloy, will be dry blended in pellet, flake, granulate, powder, or other appropriate form using conventional means such as a barrel mixer, tumble mixer, Henschel mixer, Banbury mixer, ribbon blender, and the like. The polymer components and compatibilizers may be mixed individually or in any combination in order to form one or multiple dry blends. Any liquid compatibilizers will remain separate. Alternatively, each individual polymer component, compatibilizer or dry blend of any combination of these elements can be stored separately for metering into the mixing apparatus.

The dry blend will be fed into the mixing apparatus, preferably an extruder, more preferably a twin-screw extruder, most preferably a CRNI twin-screw extruder through a feed port using a standard gravimetric or other metering device. Alternatively, each polymer component, compatibilizer, or mixed subset of components and/or compatibilizers can be metered and added to the extruder through separate feed ports.

In addition to the polymer components and compatibilizers, the polymer blend can include inorganic fillers in order to produce a polymer compound. These fillers include but are not limited to: calcium carbonate, silica, mica, clay, flyash, aluminum trihydrate and metal oxides, which enhance such properties as impact strength, tensile strength, compressive strength and flame retardancy. These fillers, their properties, and the appropriate weight percentage ranges for inclusion in various polymer blends are well known to those skilled in the art. Other useful additives include but are not limited to: lubricants, surfactants, colorants, pigments, and foaming agents. Again, these materials may be dry blended with the polymer components, and compatibilizers, or fed directly into the extruder through the appropriate feed ports.

The compatibilizers will be added into the mix of polymer components, either prior to the extruder in the dry blend and/or separately at an extruder feed port, at a specified weight percentage. The weight percentage of an individual compatibilizer and the total weight percentage of all compatibilizers to the total weight percentage of all polymer components will vary depending upon the desired final properties of the polymer blend. This in turn is dependent on the selection and weight percentage of the individual polymer components in the mix. The ratio of compatibilizers to polymer components will be within the range of 100:1 to 1:100. Preferably the weight percent of compatibilizers to the total polymer blend weight will be from 2% to 50%, more preferably from 3% to 35% and most preferably from 5% to 15%.

The various mixtures of polymer components and compatibilizers are normally metered into a conveying zone of the CRNI twin-screw extruder. This typically takes the form of a forward pitch single flighted screw, whose flights are matched to maximize its conveying properties. The L/D ratio of the conveying zone is normally in the range of 6:1 to 12:1.

A dispersive mixing zone, whose main purpose is to reduce the size of the polymer particles and provide sufficient shear and viscous heating to melt all of the polymer components and compatibilizers, usually follows this. In a CRNI twin-screw extruder the melting is usually accomplished with a cylinder or other dispersive screw element of large enough diameter to provide the shear required to melt all of the polymer constituents of the mixture to be blended. The choice of cylinder diameter is important. If it is too small, the polymer blend will not be completely melted. If it is too large, the short distance between the cylinder and the barrel wall will lead to excessive shear, viscous heating and the resultant polymer degradation. The cylinder typically has an L/D ratio in the range from 1:1 to 2:1.

After the polymer blend has been completely melted, it normally enters a predominantly distributive mixing zone. For the CRNI twin-screw extruder, this is typically composed of a forward pitched single flighted screw whose flights are staggered by 50%. That is, the flights of one screw are placed in the middle of the flights of the other screw. This results in optimal distributive mixing by maximizing the reorientation and recombination of the material as it is transferred from one screw to the other. This continual stretching and folding of the polymer blend leads to an exponential decrease in the diameter of the stretched threads and subsequent drop formation as the threads disintegrate. The distributive mixing section will have a minimal L/D of 6:1 and preferably it is longer than 12:1. Placing a double reverse pitch flighted screw element at the end of the distributive mixing zone may be advantageous in that it creates a backward flow at the end of the zone. This results in the polymer blend having a longer residence time in the extruder resulting in more mixing for a given L/D ratio. It is particularly advantageous in the case of reactive compatibilization, where the chemical reaction requires a minimum amount of time to approach completion.

Although devolatilization will not be required for all polymer blends produced by this process, it is advantageous for those polymers that degrade in the presence of water or volatile compounds such as solvents. The polymer blend may be devolatilized in the distributive mixing section or proceed through another zoning element into a separate zone for that purpose. The zoning element can be another cylinder of the same or smaller diameter to minimize further material degradation due to shear. The devolatilization zone usually consists of the same screw elements as the distributive mixing zone. These elements also lead to maximum surface regeneration, which is a key requirement for efficient out gassing of the polymer material. A zoning element is also placed at the exit to the devolatilization section. The zoning elements on both ends of the devolatilization zone enable the polymer material to form a seal to the ambient pressure at the feed entrance and die exit of the extruder. The devolatilization zone is evacuated through a vent in the extruder wall via a vacuum pump. The maximum desirable gas pressure in this evacuated region is on the order of 25 Torr. Obviously, the lower the vacuum pressure the better. The screws should be counter rotating in the downward direction below the vent to prevent clogging with polymer material. Typically the root diameter of the flighted screw elements is small in this zone to ensure that the screws are only partially filled. This also helps to avoid clogging the vacuum vent. Sparingly soluble liquid or gas stripping agents may be injected at high pressure to assist in devolatilization. The devolatilization zone will have a minimal L/D of 6:1 and preferably it is longer than 12:1.

The devolatilization zone will typically be followed by another conveying zone leading to the extrusion die. The extrusion die may be a flat plate with a number of shaped holes for the purpose of extruding strands, which are then pelletized preferably under water. Under water pelletizers are commercially available. Any appropriately comminuted shape may be extruded and cut to size using a flat plat die.

Alternatively, a finished or semi-finished product may be extruded as a solid, hollow, or perforated profile of any desired cross sectional form. The outside perimeter can be defined through the use of any continuous or stepwise continuous polygonal shape. The extruded profiles will be processed through the necessary vacuum sizers, water spray table, pulling devices, and cut to the required product lengths. These pieces of equipment and their operation are well known to those skilled in the art.

Tables IA and IB list blends of multiple immiscible polymer components which are noteworthy in that they do not contain any polyolefin components. Regarding Table IB, the polymer blend was prepared using a counter rotating non-intermeshing (CRNI) twin-screw extruder (Welding Engineers 2″ CRNI). All polymer components were obtained as post industrial waste from a local vendor in a granulated form with a ⅜″ or less size specification. All polymer components were then dry blended into a homogeneous mixture using a ribbon blender prior to being gravimetrically metered into the feed throat of the extruder. The screw elements as well as the temperature of the oil heaters on the extruder were chosen to result in a melt temperature at the extruder die of 200 degrees C. The screw elements were also chosen to zone the extruder to allow for predominantly dispersive mixing, distributive mixing and devolatilization in successive zones. The polymer blend was mixed at a rate of 235 kg per hour with a screw speed of 265 revolutions per minute. The material was extruded through a 1″ cylindrical die and quenched in a tank of water. The rods of the polymer blend were subsequently cut to the sizes required for ASTM testing. Samples were also cryogenically cooled and fractured for analysis using a scanning electron microscope (SEM).

TABLE IA

| | Weight Percent |
|---|---|
| Polymer Component | |
| Acrylonitrile Butadiene Styrene | 20% |
| General Purpose Polystyrene | 20% |
| Polyvinyl Chloride | 20% |
| Compatibilizers | |
| High Impact Polystyrene | 20% |
| Polymethyl Methacrylate | 20% |

TABLE IB
SAMPLE 1

| | Weight Percent |
|---|---|
| Polymer Component | |
| Acrylonitrile Butadiene Styrene | 19% |
| General Purpose Polystyrene | 19% |
| Polyvinyl Chloride | 19% |
| Compatibilizers | |
| High Impact Polystyrene | 24% |
| Polymethyl Methacrylate | 19% |

Table II lists the results of the ASTM tests on the polymer blend. All test results and their standard deviations are based upon 5 samples for each test.

TABLE II

| Test Results (Average of | | ASTM Test Procedure |
|---|---|---|
| 5 samples) | | |
| Compression Properties | | ASTM D 695 |
| Compressive Strength (psi) | % Compressed | Tangent Modulus (psi) |
| 8057.0 +/− 247.8 | 15.64 +/− 1.64 | 85671.4 +/− 6328.0 |
| Flexural Properties | | ASTM D 790 |
| Flexural Strength (psi) | | Tangent Modulus (psi) |
| 4479.0 +/− 889.8 | | 325500.1 +/− 76348.0 |
| Tensile Properties | | ASTM D 638 |
| Tensile Strength (psi) | % Elongation | Tangent Modulus (psi) |
| 2216.7 +/− 953.9 | 0.9 +/− 0.5 | 315490.0 +/− 57668.8 |
| IZOD Impact | | ASTM D 256 |
| 0.266 +/− 0.024 ft-lb/in | | |
| Coefficient of Linear Thermal | | ASTM D 696 |
| Expansion | | |
| Coefficient of Expansion | | |
| (−30 deg. C. to +30 deg. C.) | | |
| per deg. C. | | |
| 6.61 e−05 +/− 0.04 e−05 | | |

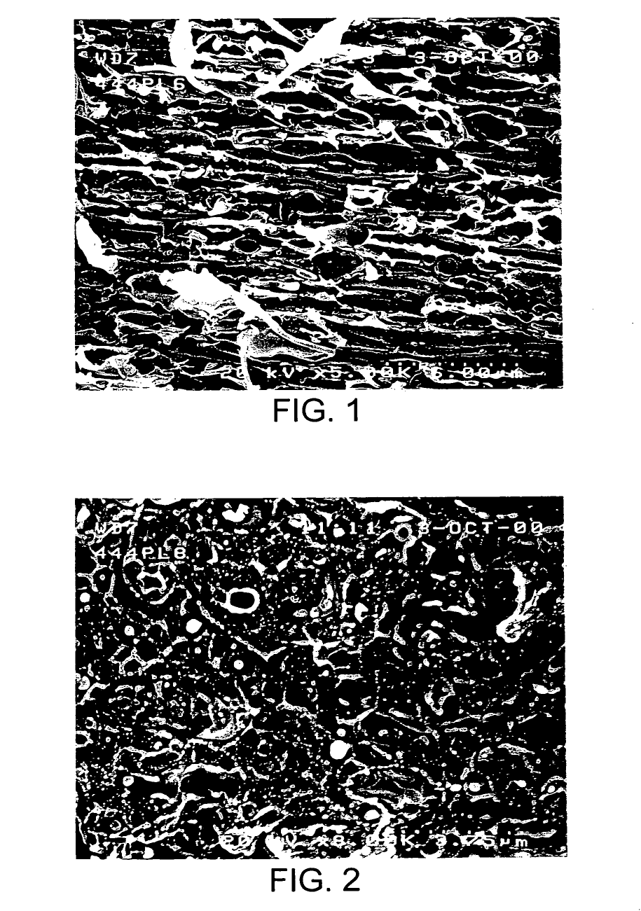

Rectilinear specimens were cut from the lateral surface of a polymer blend rod sample, cooled in a bath of liquid nitrogen, and fractured so as to expose views of the polymer blend morphology normal to and parallel to the direction of flow. FIG. 1 and FIG. 2 are representative of the photographic results obtained with the SEM. FIG. 1 is typical of the fractured surface near the outer layer of the rod. It was taken parallel to the direction of the flow. It is clearly dominated by a large number of sub-micron diameter threads, which have not disintegrated into drops. Instead they have been frozen in place as the result of the rapid quenching of the rod's outer surface when it comes into contact with water. This filamentary structure accounts in part for the high level of flexural and tensile strengths at break, as well as the high modulus associated with these properties. FIG. 2 is also of a fractured surface taken parallel to the direction of flow. However, the fractured surface is located much closer to the center of the rod sample. In this location rapid quenching would not be expected, and the normal drop-in-matrix morphology would be anticipated. It is evident from the SEM photograph that the polymer blend of equal weight percentages of five different polymers consists largely of a minor component of sub-micron drops suspended in a matrix with a substantially smaller feature size. From these figures it is apparent that the physical and chemical compatibilization of this blend of multiple immiscible polymers has succeeded.

In order to manufacture and test further multi-polymer blends, additional samples were created using the same counter rotating non-intermeshing (CRNI) twin-screw extruder (Welding Engineers 2″ CRNI) with screw elements modified as appropriate for each of the blends. All polymer components were again obtained as post industrial waste from a local vendor in a granulated form with a ⅜″ or less size specification. Clearly, each component could just as easily have been obtained as virgin resin in pellet or other form. The multi-polymer blends were prepared essentially in the same manner as described previously. Components of the three sample blends are listed in Tables III through V. Relevant processing parameters for each of the additional samples are given in Table VI.

TABLE III
SAMPLE 2

| | Weight Percent |
|---|---|
| Polymer Component | |
| General Purpose Polystyrene | 18% |
| High Density Polyethylene | 18% |
| Polypropylene | 18% |
| Polyvinyl Chloride | 18% |
| Compatibilizers | |
| High Impact Polystyrene | 23% |
| Polymethyl Methacrylate | 5% |

TABLE IV
SAMPLE 3

| | Weight Percent |
|---|---|
| Polymer Component | |
| High Density Polyethylene | 22% |
| General Purpose Polystyrene | 17% |
| Polypropylene | 17% |
| Polyethylene Terephthalate | 5% |
| Fluorinated Ethylene Propylene | 4% |
| Polyamide | 4% |
| Compatibilizers | |
| High Impact Polystyrene | 24% |
| Polymethyl Methacrylate | 7% |

TABLE V
SAMPLE 4

| | Weight Percent |
|---|---|
| Polymer Component | |
| Acrylonitrile Butadiene Styrene | 29% |
| Polypropylene (Mica Filled) | 29% |
| Polyamide | 6% |
| Polycarbonate | 6% |
| Polyethylene Terephthalate | 6% |
| Polyphenylene ether + Polyamide | 6% |
| Compatibilizers | |
| High Impact Polystyrene | 6% |
| Acrylonitrile Styrene Acrylate | 6% |
| Polymethyl Methacrylate | 6% |

TABLE VI
PROCESS PARAMETERS

| Polymer Blend | Temperature (° C.) | Rate (kg/hr) | Screw Speed (RPM) |
|---|---|---|---|
| Sample 1 | 200 | 235 | 265 |
| Sample 2 | 205 | 225 | 380 |
| Sample 3 | 265 | 240 | 380 |
| Sample 4 | 220 | 275 | 455 |

Samples 2 through 4 were extruded through a die to produce a plastic shape. The shapes were modified for flexural tests to have nominal dimensions of 2 inches by 1 inch by 36 inches. All test results and their standard deviations are based upon seven units for each polymer blend. The results are presented in Table VII where MoE stands for modulus of elasticity and MoR is modulus of rupture. The standard deviation for the MoR of Sample 3 is large due to the fact that five of the seven samples did not break.

TABLE VII
FLEXURAL STRENGTH TEST RESULTS

| Polymer | | | |
|---|---|---|---|
| Blend | Sample 2 | Sample 3 | Sample 4 |
| MoE | 352,953 +/− 90,853 | 288,802 +/− 62,130 | 386,668 +/− 44,588 |
| (psi) | | | |
| MoR | 853 +/− 99 | 1586 +/− 405 | 1262 +/− 217 |
| (psi) | | | |

An immediate and direct application of this process is recycling commingled post-industrial and post-consumer plastic waste. As of 1996 plastics in products in U.S. municipal solid wastes—which does not include plastics in industrial process wastes, automobile bodies, or construction and demolition debris—accounted for 19.8 million tons or 9.4% of the total waste generated. However, only 1.1 million tons or 5.4% of that plastic waste was recovered. This is due to the fact that attempts at manufacturing products from unsorted commingled plastic waste have been commercially unsuccessful. Indeed, the vast majority of plastic recycling consists of PET soft drink bottles and high-density polyethylene (HDPE) milk and water bottles, which are reused as homopolymers. The method disclosed here will make the blending of commingled plastic waste from post-industrial and post-consumer sources commercially viable.

The polymer blends can generally be used in any application in which plastics are currently used. For example, the blends can be used to make bottles, toys, decking, park benches, sea walls, insect barriers, doors, bricks, construction blocks, highway signage, highway sound barriers, or highway guard rail posts.

Although the subject invention disclosed herein has been described with reference to preferred embodiments, it will be understood by those skilled in the art that these embodiments are merely illustrative of the principles and application of the subject invention. It is therefore to be understood that numerous modifications may be made to the embodiments and that other applications and embodiments may be devised without departing from the spirit and scope of the subject invention.

1. A method of making a polymer blend, the method comprising combining a first polymer, a second polymer, and a third polymer in the presence of a first compatibilizer and a second compatibilizer, wherein the first polymer and the second polymer are immiscible, and wherein the second polymer and the third polymer are immiscible.

2. The method of claim 1, wherein the method comprises melt compounding.

3. The method of claim 1, wherein the first polymer and the third polymer are immiscible.

4. The method of claim 1, wherein the viscosity ratio between the first polymer and the second polymer is at least 10.

5. The method of claim 1, wherein the viscosity ratio between the second polymer and the third polymer is at least 10.

6. The method of claim 1, wherein the viscosity ratio between the first polymer and the third polymer is at least 10.

7. The method of claim 1, wherein the first compatibilizer is capable of compatibilizing the first polymer and the second polymer.

8. The method of claim 1, wherein the second compatibilizer is capable of compatibilizing the second polymer and the third polymer.

9. A composition comprising: (a) a first polymer; (b) a second polymer; (c) a third polymer; (d) a first compatibilizer; and (e) a second compatibilizer, wherein the first polymer and the second polymer are immiscible, and wherein the second polymer and the third polymer are immiscible.

10. The composition of claim 9, wherein the first polymer and the third polymer are immiscible.

11. The composition of claim 9, wherein the viscosity ratio between the first polymer and the second polymer is at least 10.

12. The composition of claim 9, wherein the viscosity ratio between the second polymer and the third polymer is at least 10.

13. The composition of claim 9, wherein the viscosity ratio between the first polymer and the third polymer is at least 10.

14. The composition of claim 9, wherein the first compatibilizer is capable of compatibilizing the first polymer and the second polymer.

15. The composition of claim 9, wherein the second compatibilizer is capable of compatibilizing the second polymer and the third polymer.

16. The composition of claim 9 wherein the composition comprises substantially no polyolefin.

17. The composition of claim 9 wherein the composition comprises less than 50% by weight polyolefin.

18. The composition of claim 9 wherein the composition comprises less than 70% by weight polyolefin.

19. The composition of claim 9 wherein the composition comprises less than 90% by weight polyolefin.

20. The method of claim 1, wherein one or more polymer components are obtained as virgin resins.

21. The method of claim 1, wherein one or more polymer components are obtained as recycled materials consisting of post-industrial waste.

22. The method of claim 1, wherein one or more polymer components are obtained as recycled materials consisting of post-consumer waste.

23. The method of claim 1, wherein the polymer components are obtained as a combination of virgin resins, post-industrial waste and post-consumer waste.

24. The method of claim 23, wherein the polymer components obtained as post-consumer waste represent no more than 75% of the polymer blend by weight.

25. The method of claim 23, wherein the polymer components obtained as post-consumer waste represent no more than 50% of the polymer blend by weight.

26. The method of claim 23, wherein the polymer components obtained as post-consumer waste represent no more than 25% of the polymer blend by weight.

27. The method of claim 23, wherein the polymer components obtained as post-consumer waste represent no more than 10% of the polymer blend by weight.

28. The method of claim 1, wherein one or more compatibilizers are obtained as virgin resins.

29. The method of claim 1, wherein one or more compatibilizers are obtained as recycled materials consisting of post-industrial waste.

30. The method of claim 1, wherein one or more compatibilizers are obtained as recycled materials consisting of post-consumer waste.

31. The method of claim 1, wherein the compatibilizers are obtained as a combination of virgin resins, post-industrial waste and post-consumer waste.

32. The method of claim 31, wherein the compatibilizers obtained as post-consumer waste represent no more than 75% of the total compatibilizer mix by weight.

33. The method of claim 31, wherein the compatibilizers obtained as post-consumer waste represent no more than 50% of the total compatibilizer mix by weight.

34. The method of claim 31, wherein the compatibilizers obtained as post-consumer waste represent no more than 25% of the total compatibilizer mix by weight.

35. The method of claim 31, wherein the compatibilizers obtained as post-consumer waste represent no more than 10% of the total compatibilizer mix by weight.

36. The composition of claim 9, wherein one or more polymer components are obtained as virgin resins.

37. The composition of claim 9, wherein one or more polymer components are obtained as recycled materials consisting of post-industrial waste.

38. The composition of claim 9, wherein one or more polymer components are obtained as recycled materials consisting of post-consumer waste.

39. The composition of claim 9, wherein the polymer components are obtained as a combination of virgin resins, post-industrial waste and post-consumer waste.

40. The composition of claim 39, wherein the polymer components obtained as post-consumer waste represent no more than 75% of the polymer blend by weight.

41. The composition of claim 39, wherein the polymer components obtained as post-consumer waste represent no more than 50% of the polymer blend by weight.

42. The composition of claim 39, wherein the polymer components obtained as post-consumer waste represent no more than 25% of the polymer blend by weight.

43. The composition of claim 39, wherein the polymer components obtained as post-consumer waste represent no more than 10% of the polymer blend by weight.

44. The composition of claim 9, wherein one or more compatibilizers are obtained as virgin resins.

45. The composition of claim 9, wherein one or more compatibilizers are obtained as recycled materials consisting of post-industrial waste.

46. The composition of claim 9, wherein one or more compatibilizers are obtained as recycled materials consisting of post-consumer waste.

47. The composition of claim 9, wherein the compatibilizers are obtained as a combination of virgin resins, post-industrial waste and post-consumer waste.

48. The composition of claim 47, wherein the compatibilizers obtained as post-consumer waste represent no more than 75% of the total compatibilizer mix by weight.

49. The of composition claim 47, wherein the compatibilizers obtained as post-consumer waste represent no more than 50% of the total compatibilizer mix by weight.

50. The composition of claim 47, wherein the compatibilizers obtained as post-consumer waste represent no more than 25% of the total compatibilizer mix by weight.

51. The composition of claim 47, wherein the compatibilizers obtained as post-consumer waste represent no more than 10% of the total compatibilizer mix by weight.

52. The method of claim 2, wherein the melt compounding is performed by an extruder.

53. The method of claim 2, wherein the melt compounding is performed by a single screw extruder.

54. The method of claim 2, wherein the melt compounding is performed by a twin screw extruder.

55. The method of claim 2, wherein the melt compounding is performed by a twin screw closely intermeshing extruder.

56. The method of claim 2, wherein the melt compounding is performed by a twin screw partially intermeshing extruder.

57. The method of claim 2, wherein the melt compounding is performed by a twin screw non-intermeshing extruder.
